(19) United States
(12) Patent Application Publication
(10) Pub. No.: US 2004/0140331 A1
(43) Pub. Date: Jul. 22, 2004

(54) Fish stringer with one way tip

(76) Inventor: Glen Allen Yarbrough, Nashville, TN (US)

Correspondence Address: Glen Allen Yarbrough, 494 Deer Ridge LN, Nashville, TN, 37221, US

(21) Appl. No.: 10/751,610

(22) Filed: Jan. 5, 2004

Related U.S. Application Data
(60) Provisional application No. 60/438,093, filed on Jan. 7, 2003.

(51) Int. Cl. A01K 1/00

(52) U.S. Cl. 224/103; 43/4

(57) ABSTRACT

An apparatus for the purpose of securing fish after catch with a tip with cord attachment positioned for the purpose of allowing piercing and or passage through fish lip or gill while subsequently forbidding the tip to come back through the passage without assistance of user. In the preferred embodiment the cord is attached to a rigid tip in any other position than either extreme end. This unique positioning of fixation of cord to tip allows tip, after passed through narrow opening in fish, to be prevented to reverse passage through opening, unless assisted, thereby retaining fish on stringer from the moment loaded. The preferred embodiment also allows user to load fish without ever having to remove stringer from fixed anchor position thereby preventing loss of entire stringer. In addition, the preferred embodiment allows user easy access to tip thereby user may load fish with a one hand operation.

### CROSS REFERENCE TO RELATED APPLICATIONS

This application is based on provisional application serial No. 60/438,093, filed on Jan. 7, 2003.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of sport fishing and more specifically to an apparatus for the purpose of securing fish after catch.

The means to secure fish dates back as long as history itself. The oldest form of this technology was accomplished by means of a basket or cage to keep fish in after catch. Then came the cord assemblies. They have been formed in many different configurations and have come to be known as a “stringer”.

A mainstay stringer construction comprises a length of cording which includes a rigid threading needle that is attached to one extreme end and on the opposite end is secured a ringed eyelet. The first fish secured to the stringer becomes an end stop. The first fish mounted on stringer is accomplished by running needle through fish gill or lip and then through eyelet. By securing additional fish the entire stringer must be removed from anchor position so that threading needle would be accessible. More recent advancements in technology have been to provide individual securing devices along the plurality of cord or chain so that each fish may be loaded and unloaded individually.

The common embodiment of stringer with a needle and eyelet on opposite ends of a length of cord is that after the first fish is loaded the stringer must be detached from anchor position. In doing so there are three significant disadvantages. The first is that the user is put at risk of losing the whole stringer especially in the case of standing in running water. The second is that the process of loading the fish is usually a two hand operation which leaves the fisherman no hand to hold the pole of net during the process. Third is that the first fish is not accessible after other fish are loaded unless fisherman unloads all of the fish.

Varieties of improvements have been made to the basic cord stringer over the years. Some assemblies provide a number of slide mounted retainers which mount along the cording and which separately secure individual fish, one example is shown at U.S. Pat. No. 4,124,154. The retainers of the latter reference are able to separately rotate about the cording member. Other retainers are known which include swivels with each retainer. Fish removal, however, still requires a separate handling of each fish. Also, the necessary rigid properties of the retainers that run the plurality of stringer cause problems with mobility and damage. If attached to person the individual retainers will rub a fisherman's leg while walking. Another consideration, and more common, is the reluctance to tie this type of stringer to boat as it will obviously cause damage as it scratches the exterior of boat during operation. And, most significantly, the fisherman is prohibited from loading fish with one hand.

### BRIEF SUMMARY OF THE INVENTION

The primary object of the invention is to secure fish after catch in such a manner that by configuration of one-way tip the fish, once loaded, may not come loose by any other means than at user discretion.

Another object of the invention is to provide a means by which a fisherman may continually keep stringer anchored to person or any other anchor point throughout the process of loading fish on said stringer.

Another object of the invention is to fix the one-way tip of stringer in such a way that user may have ready access for loading.

A further object of the invention is to provide a simple, yet effective, method of attaching the opposite end of stringer to anchor device while at the same time allowing for length of cord from one-way tip to anchor device to be adjustable at user discretion.

Yet another object of the invention is to fix one-way tip of stringer in such a way that user may detach and reattach with the use of only one hand, thereby keeping the other free to handle a rod or net.

Other objects and advantages of the present invention will become apparent from the following descriptions, taken in connection with the accompanying drawings, wherein, by way of illustration and example, an embodiment of the present invention is disclosed.

In accordance with the present invention, a stringer comprises a body having two opposite ends, a tip at one end of the body an extension at the opposite end of the body, and a cord attachment between the two opposite ends.

In accordance with a preferred embodiment of the invention, there is disclosed an apparatus for the purpose of securing fish after catch with one hand operation comprising: a securing device by any means for the tip as outlined in claim 1, that provides quick and easy removal for one hand fish loading.

In accordance with a preferred embodiment of the invention, there is disclosed an apparatus constructed as a continuous molded unit to reduce manufacturing cost with following functions comprised within and as described as an anchor device, to attach said anchor device to variable anchor positions, to attach tip to said anchor device as described in claim 8, to attach cord end to said anchor device while allowing for easy adjustment of cord length.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention in use.

FIG. 2 is a perspective view of the one-way tip.

FIG. 3 is a perspective view of the invention in it's entirety

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

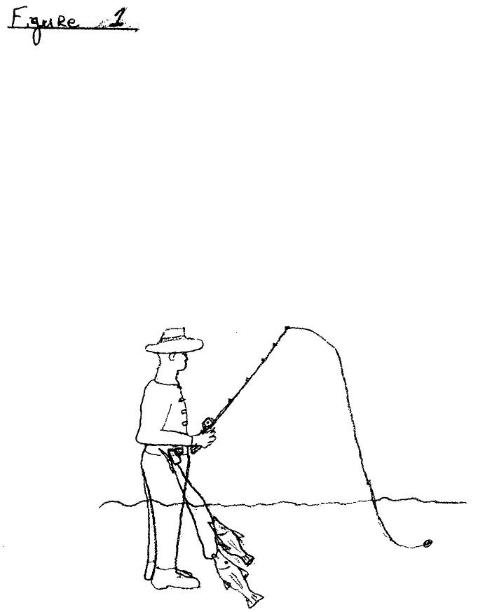

The apparatus as shown in FIGS. 1-3 is for the purpose of securing fish after catch comprising of the following features that allow for this novel technology.

Turning first to FIG. 1 there is shown a fisherman standing in a river with stringer attached to person. This is but one example of the use of the technology as outlined in this invention. Among others may be bank fishing or boat fishing.

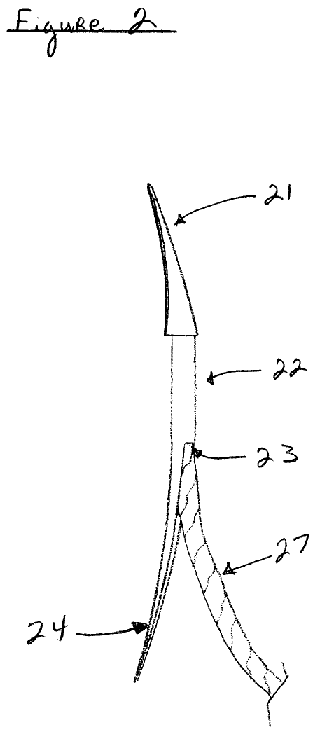

Furthermore, in the illustrated embodiment, as shown in FIG. 2, the advantage of this technology are clearly displayed. As stated in the claims section, the preferred embodiment of said stringer has a cord attachment device (23) that is not positioned at the extreme end of tip, instead is attached somewhere along the plurality of said tip. This unique attachment point facilitates the construction of a one-way extension (24) that will allow piercing and or threading through either the gill of the fish or the lip of the fish while subsequently forbidding said tip to come back through without assistance of user. The further explanation of embodiment of said tip shows a hollowed area (23) in one-way tip to allow for cord to rest within during fish loading process thereby not allowing cord to impede passage through opening.

Following the preferred procedure the embodiment is a tip (21) with a 90 degree shoulder built within to prevent a downward pull from disengaging tip from receptacle (107). Said receptacle comprising spring properties to allow for retention of tip while at the same time facilitating ready removal of tip.

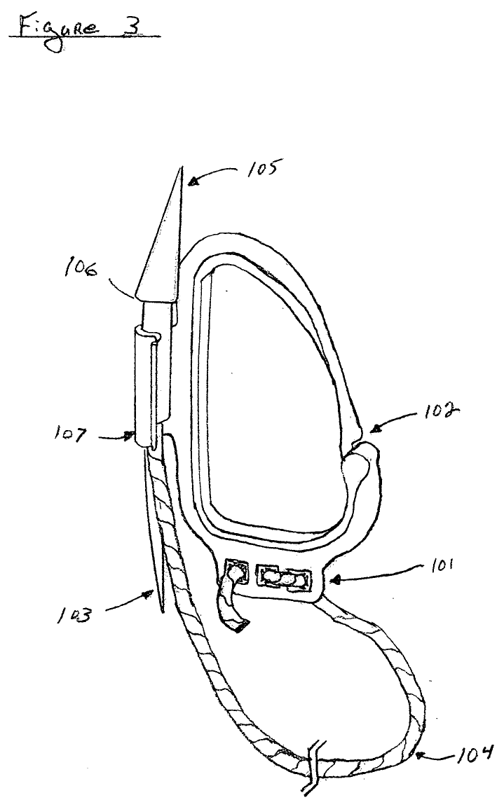

The straight shaft (22), as shown, is for the purpose of accommodating a friction fit receptacle FIG. 3 (107) for the one-way tip that provides quick and easy removal for one hand fish loading.

In FIG. 3 the drawing clearly displays the integral configuration of the anchor device (102) with an adjustable cord retention device (101) and the tip receptacle (107) built within one unit. Furthermore, the anchor device (102) is shown having a opening position for the temporary connection to variable anchor positions. This configuration provides the desired effect of decreasing manufacturing cost of entire unit while still retaining described functions.

Another possible embodiment of this technology may be to construct the anchor device with an adjustable cord retention device and the tip receptacle as independent components that would be secured to the anchor device by an means of temporary connection.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A stringer comprising: a body having two opposite ends; a tip at one end of the body; an extension at the opposite end of the body; and a cord attachment between the two opposite ends.

1. An apparatus for the purpose of securing fish after catch comprising:
a tip with cord attachment, or any other continuous material, positioned for the purpose of allowing piercing and or passage through fish lip or gill while subsequently forbidding said tip to come back through said passage without assistance of user.

2. The apparatus of claim 1 further comprising a cord or any other continuous material attached to tip at any other point other than at either end of said tip.

3. The apparatus of claim 1 further comprising a hollowed area in formation of tip to allow for cord or any other continuous material to rest within during fish loading process thereby not allowing said material to impede passage through opening.

4. The apparatus of claim 1 further comprising a curve in formation of the tip to help prevent reverse passage through pierced hole or gill of fish while at the same time providing a better means to load fish on stringer.

5. An apparatus for the purpose of securing fish after catch with one hand operation comprising:
a securing device by any means for the tip as outlined in claim 1, that provides quick and easy removal for one hand fish loading.

6. The apparatus in claim 5 further comprising a 90 degree shoulder as an integral part of shaft of tip as outlined in claim 1 to not allow for a downward pull to disengage tip from matched receptacle in claim 5 as mounted on or comprised within anchor device.

7. The apparatus in claim 5 further comprising a receptacle for tip that has spring retention properties for the purpose of retaining tip in said receptacle while at same time allowing user to readily remove tip as so desired.

8. An apparatus constructed as a continuous molded unit to reduce manufacturing cost with following functions comprised within and as described as an anchor device; to attach said anchor device to variable anchor positions, to attach tip to said anchor device as described in claim 7, to attach cord end to said anchor device while allowing for easy adjustment of cord length.

9. The apparatus of claim 8 further comprising an opening in said anchor device that has a spring tension arm built within that will allow for ready opening but yet hold secure with stress applied.

10. The apparatus of claim 8 further comprising as an integral part of said anchor device a receptacle for temporary securing of tip as described in claim 1.

11. The apparatus of claim 8 further comprising as an integral part of said anchor device a component for the expressed function of securing cord end while allowing for easy adjustment of cord length as anchor device relates to tip.
